(19) United States
(12) Patent Application Publication
(10) Pub. No.: US 2008/0226112 A1
(43) Pub. Date: Sep. 18, 2008

(54) Structure of cordless earphones

(76) Inventor: Chung-Hung Lin, Syuejia Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/717,655

(22) Filed: Mar. 14, 2007

(51) Int. Cl. H04R 25/00

(52) U.S. Cl. 381/375

(57) ABSTRACT

Cordless earphones include first earphone and second earphones connected together by means of wires, an FM (frequency modulation) receiver inside the first earphone, a Bluetooth module inside the first earphone, a chief switch button and a microphone on the first earphone, a power input terminal and a switching button on the second earphone; the chief switch button is used for turning on/off the earphones; the microphone will serve as a sound input source when a cellular phone having Bluetooth function is used with the earphones; the switching button is used for switching the earphones between an FM mode and a Bluetooth mode; thus, a wearer of the cordless earphones is allowed to listen to MP3 music files stored in an electronic device in a wireless manner, and is allowed to make a phone call with a cellular phone having Bluetooth function in a hand-free manner.

### BACKGROUND OF THE INVENTION

1. Field of the Invention

The present invention relates to an improvement on cordless earphones, more particularly one, which contains an FM receiver, and a Bluetooth module so as to receive and send out signals transmitted from FM transmitters/Bluetooth transference devices, thus allowing the user to listen to MP3 music files stored in an electronic device in a wireless manner as well as allowing the user to make a phone call with a cellular phone having Bluetooth function in a hand-free manner.

2. Brief Description of the Prior Art

Cellular phones are the most common portable electronic devices because relatively many people carry cellular phones with them wherever they go. And, MP3 players are probably in second place among all kinds of portable electronic devices because they allow people to enjoy music anywhere anytime. However, the users have to wear earphones in order to listen to MP3 music sent out from MP3 players, and the cords of the earphones are prone to cause inconvenience. Furthermore, the users aren't allowed to share MP3 music sent out from the MP3 players with other people.

Therefore, the industry developed an FM radio transmitter, which is connected to an electronic device containing MP3 music files, e.g. portable CD players, cellular phones, PDA, and MP3 players, so as to transform audio signals of the electronic device into FM signals receivable by radios/equivalents of radios. Thus, music can be sent out through the speakers connected to the radios/equivalents of radios. Such devices are generally called FM adaptors, which can be used indoors or in a car. MP3 music stored in an electronic device can be sent out for all of the people in a room/car with better audio quality through such an FM adaptor, a radio, and speakers connected to the radio after the FM adaptor is connected to the electronic device.

In order to prevent car drivers from losing concentration to cause an accident as well as preventing them from being fined owing to making phone call with their cellular phones, people developed various devices, which allow car drivers to be on a cellular phone call in a hand-free manner. In addition, application of Bluetooth wireless transference is getting common with reduction of manufacturing cost. And, cellular phones having Bluetooth function and MP3 music file storage function are getting more common.

### SUMMARY OF THE INVENTION

It is a main object of the present invention to provide an improvement on cordless earphones, which has FM receiving function and Bluetooth function; thus, after an electronic device is connected to an FM transmitter or a Bluetooth transferring device, a wearer of the cordless earphones is allowed to listen to MP3 music files stored in the electronic device in a wireless manner, and the wearer is allowed to make a phone call with a cellular phone having Bluetooth function in a hand-free manner.

Cordless earphones according to an embodiment of the present invention include first earphone and second earphones, which are connected together by means of wires. The first earphone contains an FM receiver, a Bluetooth module, a chief switch button, two adjusting buttons, and a microphone; the chief switch button is used for turning on/off the cordless earphones; the adjusting buttons are used for turning up/down the volume and for modulating a frequency of current radio waves of the FM receiver. The second earphone has a power input terminal, and a switching button for switching the earphones between a frequency modulation mode and a Bluetooth mode. The microphone will serve as a sound input source when a cellular phone having Bluetooth function is used with the earphones in the hand-free mode.

### BRIEF DESCRIPTION OF THE DRAWINGS

The present invention will be better understood by referring to the accompanying drawings, wherein:

FIG. 1 is a perspective view of the present invention in use,

FIG. 2 is a front view of the first earphone of the present invention,

FIG. 3 is a front view of the second earphone of the invention,

FIG. 4 is a perspective view of the second earphone,

FIG. 5 is a perspective view of the present invention being used in the second way,

FIG. 6 is a perspective view of the present invention being used in the third way,

FIG. 7 is a perspective view of the present invention being used in the fourth way.

### DETAILED DESCRIPTION OF THE PREFERRED EMBODIMENTS

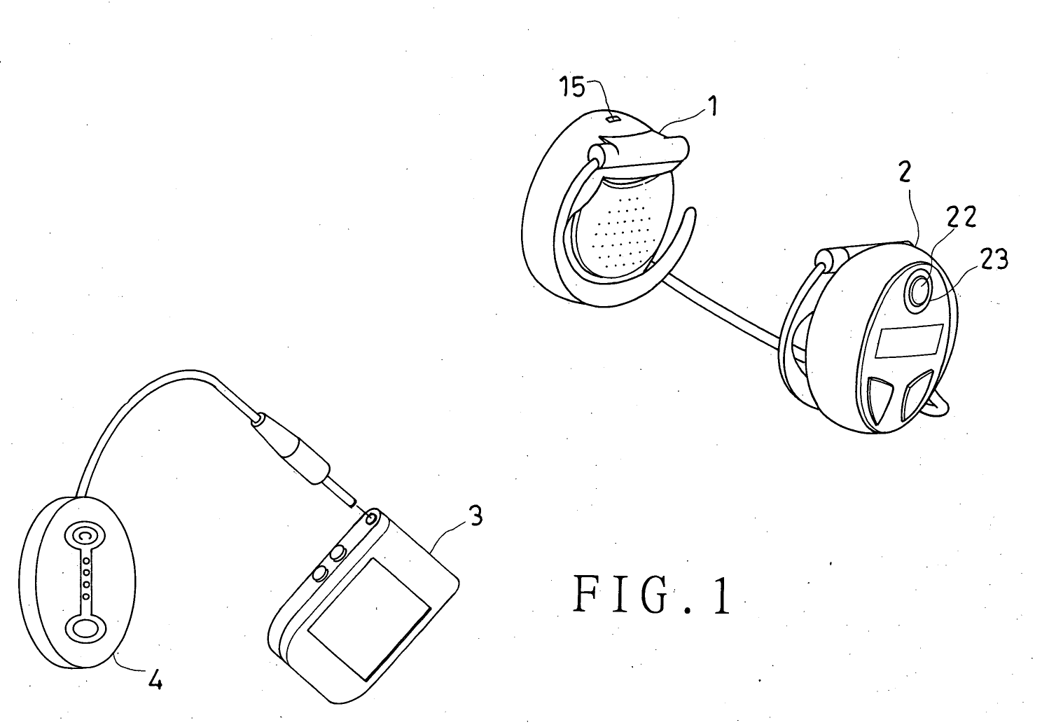

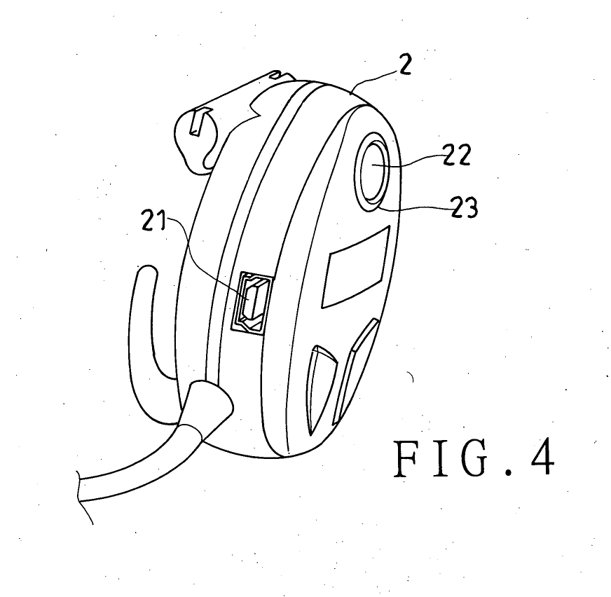

Referring to FIG. 1 to FIG. 4, a preferred embodiment of cordless earphones of the present invention includes a first earphone 1, and a second earphone 2, which is connected to the first earphone 1 by means of wires.

The first earphone 1 contains an FM (frequency modulation) receiver, and a Bluetooth module, which is used for wireless transference between it and various electronic devices 3 with Bluetooth function such as cellular phones. The first earphone 1 has a chief switch button 11 on an upper portion of a lateral side thereof for turning on/off the earphones of the present invention. The chief switch button 11 has a pervious-to-light periphery, and is equipped with a light emitting diode 12, which will shine to serve as an indicating light when the earphones are being used in a Bluetooth mode, and when the overall voltage is too low. The first earphone 1 has a liquid crystal display 13 under the chief switch button 11 for showing a frequency of current radio waves of the FM receiver. The first earphone 1 has two buttons 14 under the liquid crystal display 13 on two sides thereof. The buttons 14 can be used for turning up/down the volume or for modulating a frequency of current radio waves of the FM receiver. Furthermore, the first earphone 1 has a microphone 15 on a periphery thereof, which will be used as a sound input source when the earphones are used in order for allowing a user to make a phone call with a cellular phone in a hand-free manner.

The second earphone 2 is powered by means of batteries, and has a power input terminal therefore the batteries can be charged through the power input terminal. The second earphone 2 has a switching button 22 on an upper portion of a lateral side thereof, which can be pressed so as to carry out matching of Bluetooth modules and to switch the earphones between an FM mode and a Bluetooth mode. The switching button 22 has a pervious-to-light periphery, and is equipped with a light emitting diode 23, which will shine to serve as an indicating light when the batteries are being charged.

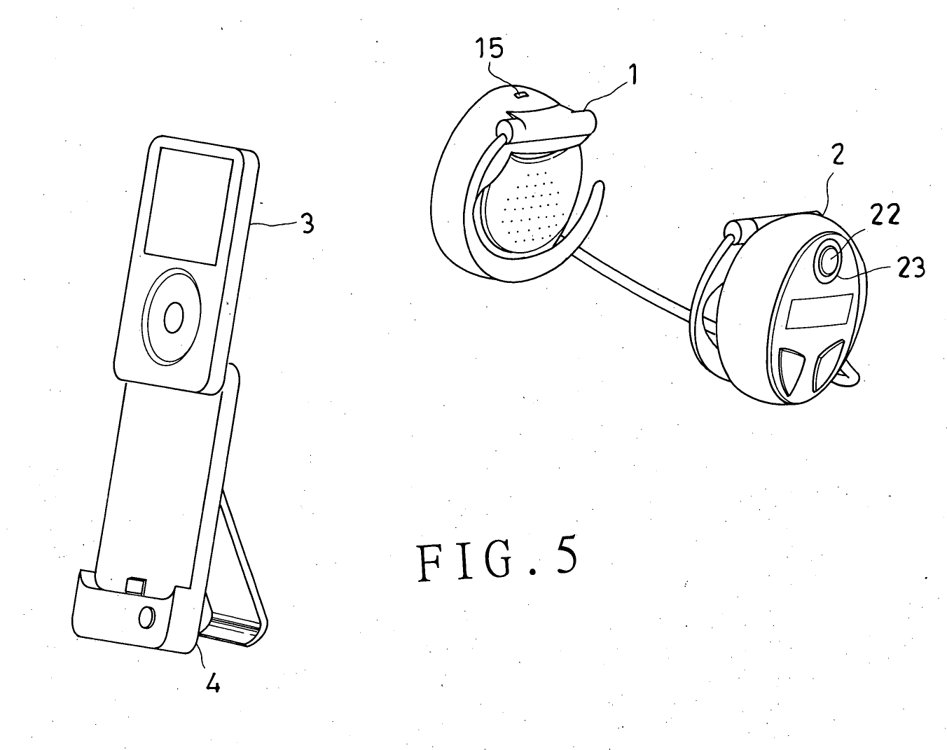

Referring to FIGS. 1 and 5, in use, an FM (frequency modulation) transmitter 4 is connected to an electronic device 3 containing MP3 music files such as cellular phones, iPOD, portable storage devices, and MP3 players so as to transmit signals. And, the FM receiver inside the first earphone 1 receives the signals; in other words, the cordless earphones receive signals in a wireless manner. Consequently, the wearer is allowed to listen to music of the MP3 music files stored in the electronic device 3 through the first and the second earphones 1 and 2.

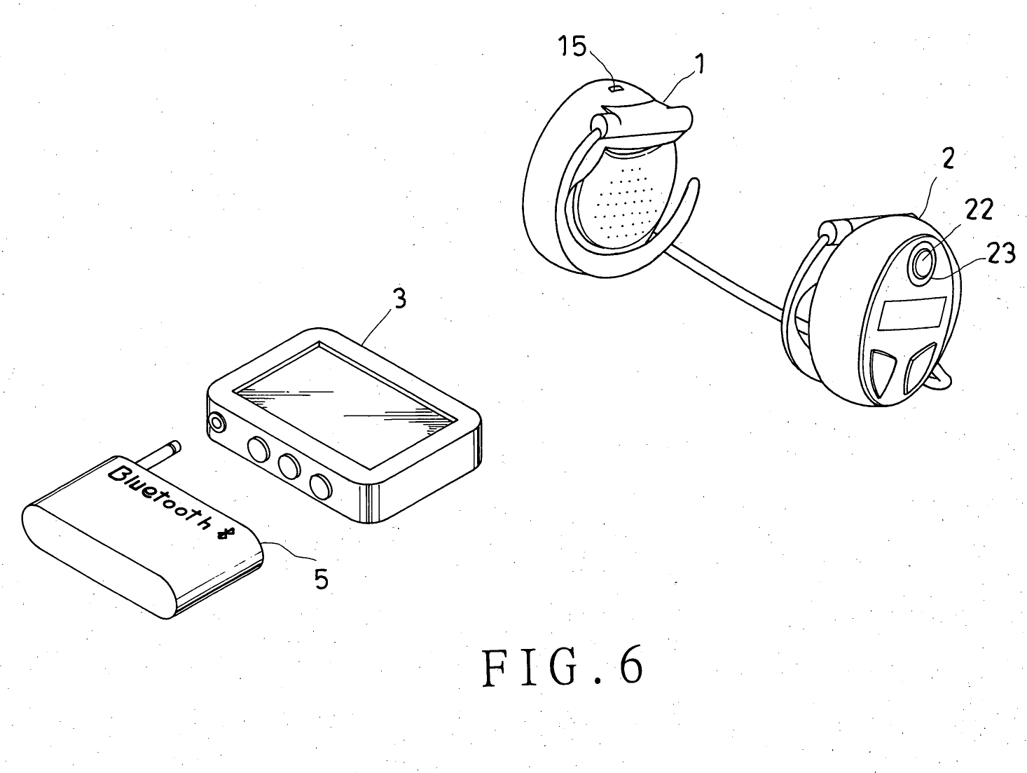

Referring to FIG. 6, a Bluetooth transferring device 5 is connected to an electronic device 3 containing MP3 music files, e.g. iPOD, portable storage devices, and MP3 players while the switching button 22 is pressed so as to make the Bluetooth transferring device 5 match the Bluetooth module inside the first earphone 1 in respect of radio communication. Thus, music signals in the electronic device 3 is transmitted through the Bluetooth transferring device 5, and received by means of the Bluetooth module inside the first earphone 1 in a wireless manner. Therefore, the wearer is allowed to listen to music of the MP3 music files stored in the electronic device 3 through the first and the second earphones 1 and 2 of the cordless earphones.

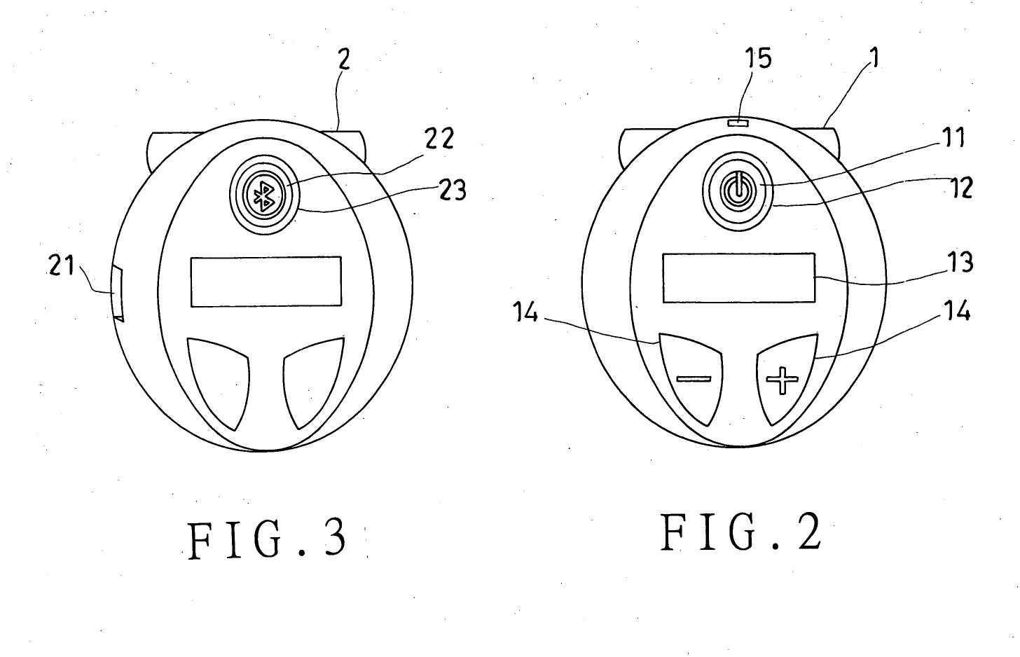

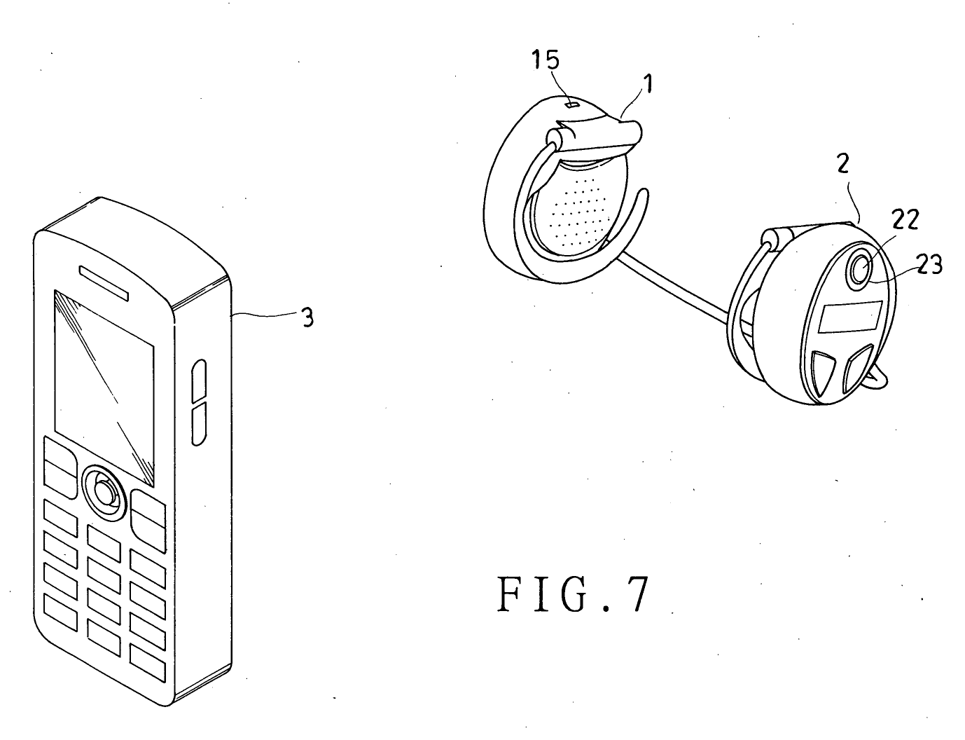

Referring to FIGS. 2 and 7, the cordless earphones of the present invention can be used with cellular phones having Bluetooth transference function as well as having MP3 music files stored therein, which kind of cellular phones are getting popular. To use the cordless earphones together with such a cellular phone, first the switching button 22 of the second earphone 2 is pressed so as to make the Bluetooth module inside the first earphone 1 match with the cellular phone in respect of radio communication. Then, MP3 music files stored in the cellular phone are transferred to the Bluetooth module inside the first earphone 1 in the way of Bluetooth wireless transference, and sent out through the first and the second earphones 1 and 2. In addition, when the cellular phone starts ringing while the user is driving, the user should press the switching button 22 so as to answer the phone call and to switch the cordless earphones to the hand-free mode, in which mode the driver is allowed to be on the phone in a hand-free manner, and the microphone 15 fitted on the first earphone 1 serves as an sound input source for the driver; the light emitting diode 12 of the first earphone 1 will start shining to indicate that there is an incoming phone call. The driver is allowed to press the switching button 22 to switch the cordless earphones back to the FM mode in order for the earphones to receive FM signals after the phone call has been finished.

From the above description, it can be seen that the present invention has the following advantages:

1. The first earphone of the cordless earphones of the present invention has an FM receiver inside. When an FM transmitter is connected to an electronic device containing MP3 music files such as cellular phones, iPOD, portable storage devices, and MP3 players to transmit signals, the FM receiver will receive the signals. Consequently, the wearer is allowed to listen to music of the MP3 music files stored in the electronic device through the first and the second earphones.

2. The first earphone of the present invention has a Bluetooth module. Therefore, besides receiving signals through the FM receiver, the first earphone will received signals from a Bluetooth transferring device through the Bluetooth module after the Bluetooth transferring device is connected to an electronic device containing MP3 music files so as to transmit signals in the electronic device, which can be an iPOD, a portable storage device or an MP3 player.

3. The first earphone of the present invention has a Bluetooth module. Therefore, after the Bluetooth module is made to match with a cellular phone with Bluetooth transference function in respect of radio communication, MP3 music files stored in the cellular phone will be transferred to the Bluetooth module inside the first earphone in the way of Bluetooth wireless transference. In addition, owing to the Bluetooth module inside the first earphone, the wearer of the cordless earphones is allowed to use the cellular phone in a hand-free manner, wherein the microphone fitted on the first earphone serves as a sound input source, and the first and the second earphones serve as a sound output source.

What is claimed is:

1. An improvement on a structure of cordless earphones, comprising
a first earphone,
a second earphone connected to the first earphone by means of wires,
a frequency modulation receiver for receiving frequency modulation signals,
a Bluetooth module for performing wireless transference between it and electronic devices having Bluetooth function,
a microphone, said microphone serving as a sound input source when a cellular phone having Bluetooth function is used with said earphones, and
a switching button for switching between a frequency modulation mode and a Bluetooth mode.
